(19) United States
(12) Patent Application Publication
(10) Pub. No.: US 2016/0246104 A1
(43) Pub. Date: Aug. 25, 2016

(54) LIQUID CRYSTAL DISPLAY DEVICE AND METHOD OF MANUFACTURING THE SAME

(71) Applicant: FUJIFILM Corporation, Tokyo (JP)

(72) Inventors: Satoru YAMADA, Shizuoka (JP); Takeshi ANDO, Shizuoka (JP); Wakahiko KANEKO, Shizuoka (JP)

(73) Assignee: FUJIFILM Corporation, Tokyo (JP)

(21) Appl. No.: 14/997,579

(22) Filed: Jan. 18, 2016

(30) Foreign Application Priority Data
Feb. 20, 2015 (JP) 2015-031636

(51) Int. Cl. G02F 1/1333; G02F 1/1339; G02F 1/1343; G02F 1/1368; G02F 1/1337

(52) U.S. Cl. CPC G02F 1/133345; G02F 1/1368; G02F 1/1337; G02F 1/134309; G02F 1/13394; G02F 1/133788; G02F 2001/133357

(57) ABSTRACT

A liquid crystal display device includes: a liquid crystal layer; a first substrate including thin-film transistors configured to drive liquid crystal molecules of the liquid crystal layer, at least one type of electrode, and an insulating film, at least a part of which is in direct contact with the liquid crystal layer; and a second substrate disposed so as to be opposed to the first substrate with the liquid crystal layer interposed therebetween. One of the at least one type of electrode is disposed on the insulating film. The insulating film has a function of aligning the liquid crystal molecules of the liquid crystal layer. The insulating film formed on the thin-film transistors also serves as an alignment film configured to align the liquid crystal molecules and the structure is simplified more than before. The manufacturing process is also simplified more than before.

### CROSS-REFERENCE TO RELATED APPLICATIONS

The present application claims priority under 35 U.S.C. §119 to Japanese Patent Application No. 2015-031636, filed on Feb. 20, 2015, which is hereby expressly incorporated by reference, in its entirety, into the present application.

### BACKGROUND OF THE INVENTION

The present invention relates to a liquid crystal display device including thin-film transistors and a method of manufacturing the same. The present invention more specifically relates to a liquid crystal display device in which an insulating film formed on thin-film transistors also serves as an alignment film configured to align liquid crystal molecules of a liquid crystal layer, and a method of manufacturing the same.

Liquid crystal display devices have advantages such as small thickness, light weight and capability to reduce power consumption, and are therefore widely used in various types of electronic equipment. The liquid crystal display devices are also widely used in combination with touch panels.

In recent years, in uses in TV sets, computer displays and the like, a liquid crystal display device having a wide viewing angle is required to comply with an increase in screen size. As a display mode for widening the viewing angle, attention is focused on a so-called IPS (In-Plane Switching) mode (hereinafter also referred to simply as “IPS mode”) in which an electric field parallel to a substrate is generated to rotate liquid crystal molecules within a plane parallel to the substrate. In this IPS mode, in both the ON state and the OFF state, the major axes of the liquid crystal molecules are always substantially parallel to the substrate and the liquid crystal molecules do not undulate with respect to the substrate, and hence variations in the liquid crystal optical characteristics in accordance with the viewing angle are small and a wide viewing angle is obtained.

For example, JP 9-73101 A discloses a liquid crystal display device using the IPS mode. In the liquid crystal display device of JP 9-73101 A, pixel electrodes and counter electrodes are formed on a liquid crystal layer side surface of one or both of transparent substrates disposed so as to be opposed to each other through a liquid crystal layer, and voltages are applied between the pixel electrodes and their corresponding counter electrodes to generate electric fields parallel to the transparent substrates. In the liquid crystal display device of JP 9-73101 A, the liquid crystal alignment state and the polarization state of polarizing plates are set to block transmission of light from one transparent substrate to the other transparent substrate through the liquid crystal in a state in which no voltage is applied between the pixel electrodes and their corresponding counter electrodes, and the pixel electrodes or the counter electrodes or both are formed of a transparent conductive film.

In addition to the IPS mode, a fringe-field switching mode is known as a display mode for widening the viewing angle.

For example, JP 2007-279478 A describes an FFS (Fringe-Field Switching) mode liquid crystal display device which includes: a first substrate and a second substrate disposed so as to be opposed to each other and forming a pair; pixel electrodes and a common electrode formed on at least one of the pair of substrates through an insulating layer, with different potentials being applicable across the electrodes; a liquid crystal layer having liquid crystal molecules aligned substantially parallel to the substrate surface in a state in which no voltage is applied between the pair of substrates; and a pair of polarizing plates disposed so as to hold the liquid crystal layer therebetween, and in which the alignment of the liquid crystal layer is controlled by electric fields formed by the pixel electrodes and the common electrode. In the liquid crystal display device of JP 2007-279478 A, the thickness of the insulating layer differs within one pixel or between sub-pixels, or the dielectric constant of the insulating layer differs within one pixel or between sub-pixels.

### SUMMARY OF THE INVENTION

As described above, liquid crystal display devices are widely used and their uses in combination with touch panels are also expanding. In the liquid crystal display devices, structural simplification and simplification of their manufacturing process are required. At present, however, structural simplification and simplification of the manufacturing process are not taken into account for the liquid crystal display devices.

The present invention has been made to solve the foregoing problem associated with the conventional techniques. An object of the present invention is to provide a liquid crystal display device having a more simplified structure than before and including an insulating film formed on thin-film transistors and also serving as an alignment film configured to align liquid crystal molecules. Another object of the present invention is to provide a liquid crystal display device-manufacturing method having a more simplified manufacturing process than before.

In order to achieve the foregoing objects, the present invention provides a liquid crystal display device comprising: a liquid crystal layer; a first substrate comprising thin-film transistors configured to drive liquid crystal molecules of the liquid crystal layer, at least one type of electrode, and an insulating film, at least a part of which is in direct contact with the liquid crystal layer, one of the at least one type of electrode being disposed on the insulating film; and a second substrate disposed so as to be opposed to the first substrate with the liquid crystal layer interposed between the first substrate and the second substrate, wherein the insulating film has a function of aligning the liquid crystal molecules of the liquid crystal layer.

Preferably, the first substrate further comprises an organic planarization layer formed on the thin-film transistors, the at least one type of electrode comprises a first electrode and a second electrode formed on the organic planarization layer, the insulating film is interposed between the first electrode and the second electrode, and the first electrode is a comb-shaped electrode. The insulating film preferably has a thickness of up to 1 μm.

Preferably, the first substrate comprises the insulating film formed on the thin-film transistors, the at least one type of electrode is formed on the insulating film, the at least one type of electrode is a comb-shaped electrode, and the insulating film also serves as an organic planarization layer. The insulating film also serving as the organic planarization layer preferably has a thickness of at least 2 μm but up to 5 μm.

The insulating film preferably has photo alignment properties. An organic insulating film precursor configured to form the insulating film preferably has photo alignment properties.

Spacers configured to keep a distance between the first substrate and the second substrate are preferably formed between the first substrate and the second substrate. The spacers may be disposed at positions corresponding to the at least one type of electrode.

The present invention also provides a method of manufacturing a liquid crystal display device comprising a liquid crystal layer, and a first substrate and a second substrate disposed so as to be opposed to each other with the liquid crystal layer interposed between the first substrate and the second substrate, the method comprising: a step of forming, on the first substrate, thin-film transistors configured to drive liquid crystal molecules of the liquid crystal layer, an insulating film, and one of at least one type of electrode on the insulating film; a step of attaching the first substrate and the second substrate to each other; and a step of injecting a liquid crystal between the first substrate and the second substrate before or after the step of attaching the first substrate and the second substrate to each other so that at least a part of the insulating film comes into direct contact with the liquid crystal, wherein a step of forming the insulating film comprises a step of forming a film constituting the insulating film using an organic material having photo alignment properties and a step of imparting a function of aligning the liquid crystal molecules through irradiation of at least a part of the film with polarized light.

Preferably, formation of the thin-film transistors is followed by formation of one of the at least one type of electrode and another of the at least one type of electrode is formed on the insulating film. Formation of the thin-film transistors may be followed by formation of the insulating film, which may be followed by formation of the at least one type of electrode.

The step of forming the insulating film preferably comprises subjecting the film to heat curing treatment before or after the irradiation with the polarized light. The polarized light preferably has a wavelength of 200 nm-400 nm. The injected liquid crystal is preferably a liquid crystal to be horizontally aligned.

The liquid crystal display device according to the present invention unifies the insulating film with the alignment film to allow the structure to be more simplified than conventional liquid crystal display devices.

The liquid crystal display device-manufacturing method according to the present invention unifies the insulating film with the alignment film to allow the manufacturing process to be more simplified than in conventional liquid crystal display device-manufacturing methods.

### BRIEF DESCRIPTION OF THE DRAWINGS

FIG. 1 is a schematic cross-sectional view illustrating a structure of a liquid crystal display device according to a first embodiment of the present invention.

FIG. 2 is a schematic cross-sectional view illustrating an exemplary structure of a thin-film transistor in the liquid crystal display device according to the first embodiment of the present invention.

FIG. 3 is a flow chart illustrating a method of manufacturing the liquid crystal display device according to the first embodiment of the present invention.

FIG. 4 is a schematic cross-sectional view illustrating a structure of a liquid crystal display device according to a second embodiment of the present invention.

FIG. 5 is a schematic cross-sectional view illustrating a first example of the structure of a conventional liquid crystal display device.

FIG. 6 is a schematic cross-sectional view illustrating a second example of the structure of a conventional liquid crystal display device.

### DETAILED DESCRIPTION OF THE INVENTION

A liquid crystal display device and a method of manufacturing the same according to the present invention are described below in detail with reference to preferred embodiments shown in the accompanying drawings.

On the following pages, a hyphen (-) as used in a numerical range indicates that numerical values on both sides are included in the numerical range. For example, when ε is in a range of numerical value α—numerical value β, the range of ε includes the numerical value α and the numerical value β, and is expressed with mathematical symbols as follows: α≦ε≦β.

### First Embodiment

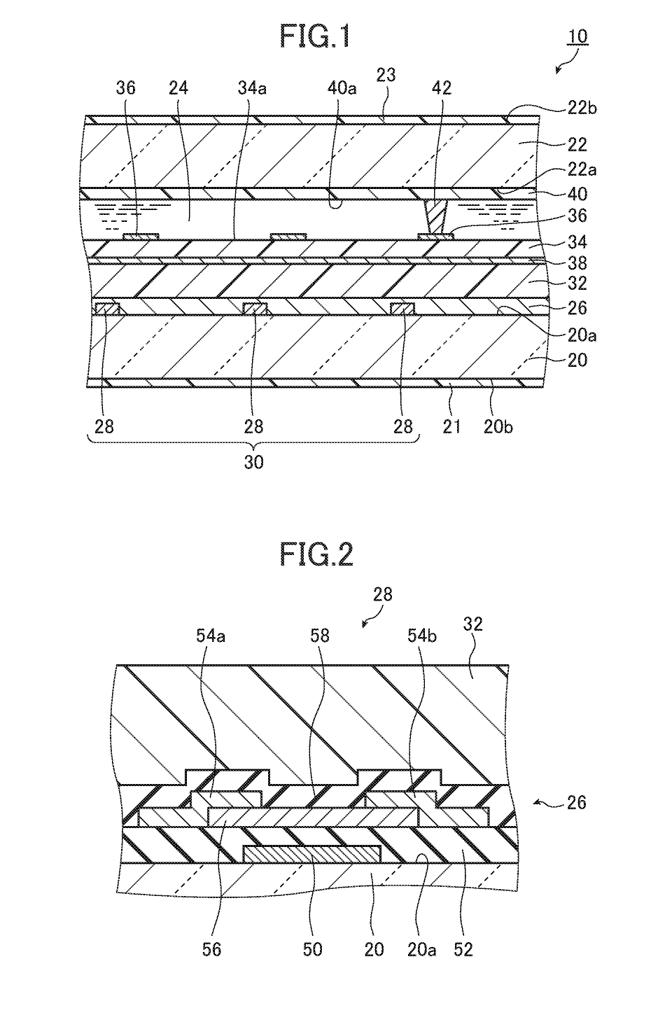

FIG. 1 is a schematic cross-sectional view illustrating a structure of a liquid crystal display device according to a first embodiment of the present invention, and FIG. 2 is a schematic cross-sectional view illustrating an exemplary structure of a thin-film transistor in the liquid crystal display device according to the first embodiment of the present invention.

A liquid crystal display device 10 illustrated in FIG. 1 is of a fringe-field switching mode.

The liquid crystal display device 10 includes a liquid crystal layer 24, and a first substrate 20 and a second substrate 22 disposed so as to be opposed to each other with the liquid crystal layer 24 interposed therebetween, and also includes at least one type of electrode. The liquid crystal layer 24 is preferably formed of a horizontally aligned liquid crystal.

A thin-film transistor array layer 26 is formed on a surface 20a of the first substrate 20 and an organic planarization layer 32 is formed on the thin-film transistor array layer 26. On the organic planarization layer 32 is formed a planar second electrode 38, for example. On the second electrode 38 is formed an alignment/insulation film 34. On a surface 34a of the alignment/insulation film 34 are formed comb-shaped first electrodes 36, for example. The surface 34a of the alignment/insulation film 34 is in contact with liquid crystal molecules (not shown) of the liquid crystal layer 24 except regions where the first electrodes 36 are formed.

An alignment film 40 is formed on a surface 22a of the second substrate 22. The first substrate 20 and the second substrate 22 are disposed in such a state that the alignment/insulation film 34 of the first substrate 20 and the alignment film 40 of the second substrate 22 are opposed to each other with the liquid crystal layer 24 interposed therebetween.

A first polarizing plate 21 is disposed on a rear surface 20b of the first substrate 20 and a second polarizing plate 23 is disposed on a rear surface 22b of the second substrate 22. The second polarizing plate 23 side is a side from which the liquid crystal display device 10 is viewed.

It should be noted that, for example, a transparent substrate such as a glass substrate or a resin substrate can be used for the first substrate 20 and the second substrate 22.

Spacers 42 for keeping the distance between the first substrate 20 and the second substrate 22 at a preset distance are formed between the first substrate 20 and the second substrate 22. Each spacer 42 is disposed on the first electrode 36 on the first substrate 20 side and on a surface 40a of the alignment film 40 on the second substrate 22 side. The spacers 42 may be disposed on the surface 34a of the alignment/insulation film 34 on the first substrate 20 side.

A spacer which is used in a known liquid crystal display device can be appropriately utilized as the spacer 42. The spacer may be columnar or spherical in shape and is not particularly limited in configuration.

The thin-film transistor array layer 26 includes a plurality of thin-film transistors 28. One thin-film transistor 28 is disposed in one region (not shown) constituting one pixel (not shown). The thin-film transistors 28 are thus arranged in a matrix on the surface 20a of the first substrate 20. The thin-film transistors 28 are collectively referred to as a thin-film transistor array 30.

The thin-film transistor 28 is configured to drive the liquid crystal molecules of the liquid crystal layer 24 which are in one region constituting one pixel. Although not shown, the first electrodes 36 or the second electrode 38 is electrically connected to the thin-film transistors 28. The thin-film transistors 28 supply image signals to the first electrodes 36 or the second electrode 38 at a predetermined voltage and the liquid crystal molecules are driven in accordance with the image signals.

The thin-film transistor 28 is configured, for example, as illustrated in FIG. 2. A thin-film transistor which is used in a known liquid crystal display device can be appropriately utilized as the thin-film transistor 28. The thin-film transistor is not particularly limited in configuration and may be of a top gate type or a bottom gate type.

In the thin-film transistor 28 illustrated in FIG. 2, a gate line 50 is formed on the surface 20a of the first substrate 20. An insulating film 52 covering the gate line 50 is formed on the surface 20a of the first substrate 20. A source portion 54a and a drain portion 54b are formed on the insulating film 52, and a semiconductor layer 56 is so formed on the insulating film 52 immediately above the gate line 50 as to connect the source portion 54a and the drain portion 54b, with the gate line 50, the source portion 54a, the drain portion 54b and the semiconductor layer 56 thus making up the thin-film transistor 28. An insulating film 58 covering the gate line 50, the source portion 54a, the drain portion 54b and the semiconductor layer 56 is formed. The organic planarization layer 32 is formed on the insulating film 58.

In the thin-film transistor 28, a conductive or non-conductive state is created between the source portion 54a and the drain portion 54b in accordance with the potential of the gate line 50. Although not shown, the gate line 50 is connected to a driving unit which has a drive circuit for driving the liquid crystal molecules of the liquid crystal layer 24.

Exemplary materials that may be used to form the gate line 50, the source portion 54a, and the drain portion 54b include transparent conductive materials such as indium tin oxide (ITO), aluminum zinc oxide (AZO), and indium zinc oxide (IZO). In addition to these, use may be made of metallic materials such as aluminum and copper, and alloy materials using these metallic materials.

The semiconductor layer 56 can be composed of materials such as amorphous silicon, polysilicon and oxide semiconductor. The thin-film transistor 28 may include a protective insulating film (passivation film) or further include a light shield layer and an insulating film.

The organic planarization layer 32 is formed to prevent irregularities that may occur on the thin-film transistor array layer 26 from adversely affecting the configuration of the overlying layer. The organic planarization layer 32 can minimize the reduction in the adhesion of the second electrode 38 that may be caused by the irregularities of the thin-film transistor array layer 26.

The organic planarization layer 32 is composed of an organic material and, for example, an organic insulating film composition (1) to be described later in detail can be used.

The alignment/insulation film 34 is an insulating film having a function of aligning the liquid crystal molecules of the liquid crystal layer 24 and also having an electrically insulating function. To be more specific, the alignment/insulation film 34 serves as an insulating film for electrically insulating the thin-film transistors 28 or the electrodes and an alignment film for aligning the liquid crystal molecules of the liquid crystal layer 24. Since the alignment/insulation film 34 aligns the liquid crystal molecules, if its surface is not flat, the alignment of the liquid crystal molecules is not uniform. Therefore, the surface 34a is flat. The surface 34a of the alignment/insulation film 34 need only have substantially the same flatness as an alignment film in a known liquid crystal display device.

The function of aligning the liquid crystal molecules refers to a function of aligning the liquid crystal molecules of the liquid crystal layer 24 in a specific direction.

The alignment/insulation film 34 is formed, for example, between the first electrodes 36 and the second electrode 38 to electrically insulate the first electrodes 36 from the second electrode 38.

The alignment/insulation film 34 is formed, for example, using an organic material having photo alignment properties but is not particularly limited. The alignment/insulation film 34 may have the photo alignment properties or an organic insulating film precursor for forming the alignment/insulation film 34 may have the photo alignment properties. The alignment/insulation film 34 can be formed using an organic insulating film composition (2) to be described later in detail. The organic insulating film precursor is, for example, the organic insulating film composition (2).

The organic insulating film composition as described herein is a composition which undergoes a curing reaction under heating to be converted to the alignment/insulation film 34. To be more specific, the curing reaction means causing an intermolecular crosslinking reaction using a crosslinkable group or causing a cyclodehydration reaction in the molecule to induce a physical change necessary for a permanent film.

In addition to electrically insulating as described above, the alignment/insulation film 34 serves to form a capacitor between the first electrodes 36 and the second electrode 38. The alignment/insulation film 34 preferably has a smaller thickness in order to increase the capacitance of the capacitor. In this case, the alignment/insulation film 34 preferably has a thickness of up to 1,000 nm, more preferably up to 200 nm, even more preferably up to 100 nm, and most preferably up to 50 nm.

Transparent conductive materials such as indium tin oxide (ITO), aluminum zinc oxide (AZO), and indium zinc oxide (IZO) can be used for the first electrodes 36 and the second electrode 38. In addition to these, use may be made of metallic materials such as aluminum and copper, and alloy materials using these metallic materials.

If a combination of a pixel electrode and a common electrode is used, one of the first electrode 36 and the second electrode 38 need only be a pixel electrode or a common electrode. A comb-shaped electrode is used as the first electrode 36, and a planar electrode as it is called a solid electrode is used as the second electrode 38. However, the forms of the first electrode 36 and the second electrode 38 are not particularly limited. The first electrode 36 may be a planar electrode and the second electrode 38 be a comb-shaped electrode.

The alignment film 40 is configured to align the liquid crystal molecules of the liquid crystal layer 24 and an alignment film that may be used in a known liquid crystal display device can be appropriately utilized.

The liquid crystal display device 10 may be of a monochrome display type or a color display type. In the case of color display, a black matrix layer is formed between mutually adjacent pixels on the second substrate 22, red, blue and green color filters corresponding to the respective pixels are formed, and an overcoat layer covering the color filters is further formed.

The liquid crystal display device 10 can be manufactured as described below.

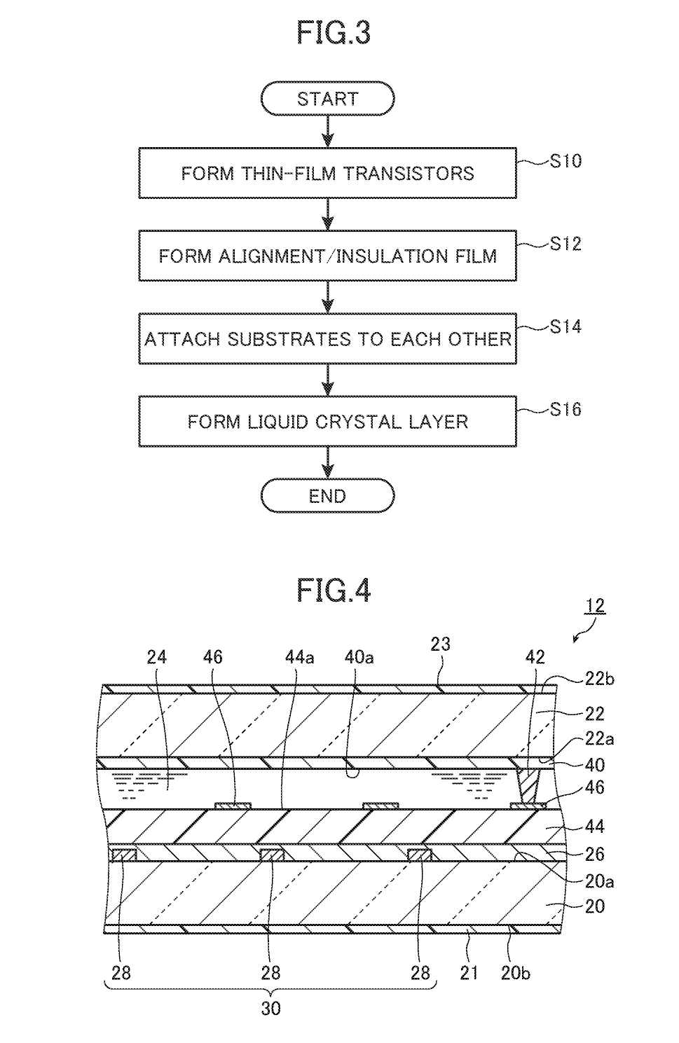

FIG. 3 is a flow chart illustrating a method of manufacturing the liquid crystal display device according to the first embodiment of the present invention.

First of all, in Step S10, a known method such as photolithography is used to form one thin-film transistor 28 in each region constituting one pixel on the surface 20a of the first substrate 20, thereby forming the thin-film transistor array layer 26.

Next, for example, the organic insulating film composition (1) to be described later in detail is applied onto the thin-film transistor array layer 26 by a spin coating process, a printing process or an application process to form a coating film. Then, the coating film is subjected to heat curing treatment at a preset temperature for a preset period of time to form the organic planarization layer 32.

Then, ITO (indium tin oxide) is used to form a transparent conductive film on the organic planarization layer 32 by, for example, a sputtering process and the transparent conductive film is then processed by, for example, a wet etching process to form the planar second electrode 38.

Next, the alignment/insulation film 34 is formed on the second electrode 38 (Step S12).

As for the alignment/insulation film 34, for example, the organic insulating film composition (2) to be described later in detail is applied onto the second electrode 38 by a printing process or an application process to form a coating film. The coating film is a film to be used as the alignment/insulation film 34. Then, the coating film is subjected to heat curing treatment at a preset temperature for a preset period of time.

Next, ITO (indium tin oxide) is used to form a transparent conductive film on the surface 34a of the alignment/insulation film 34 by, for example, a sputtering process and the transparent conductive film is then processed by, for example, a wet etching process to form the comb-shaped first electrodes 36.

Next, at least a part of the coating film after the heat curing treatment is exposed to polarized light to perform photo alignment treatment, thereby imparting the function of aligning the liquid crystal molecules. Thus, an insulating film capable of electric insulation that is also capable of aligning the liquid crystal molecules of the liquid crystal layer 24 in a specific direction, namely, the alignment/insulation film 34 is formed. The heat curing treatment is followed by the photo alignment treatment but may be preceded by the photo alignment treatment. The polarized light for use in irradiation preferably has a wavelength of 200 nm-400 nm, more preferably 220 nm-350 nm, and most preferably 250 nm-300 nm. The source of the polarized light may be a monochromatic light source (laser) or a sequential color light source having a wavelength width. From the viewpoint of an inexpensive exposure device, a sequential color light source is preferably used as the source of the polarized light.

It should be noted that the alignment/insulation film 34 is subjected to photo-patterning. To be more specific, patterning is performed to form contact holes for ensuring conduction between the transparent electrodes made of, for example, ITO and metal wiring. According to this embodiment, the photosensitive wavelength of a photoacid generator for use in patterning is, for example, a long wavelength of 365 nm.

Next, the second substrate 22 is prepared. The spacers 42 are disposed on the second substrate 22. In this case, the spacers 42 are disposed at corresponding positions on the first electrodes 36 located on the first substrate 20 side. The spacers 42 may be disposed on the surface 34a of the alignment/insulation film 34 on the first substrate 20 side. The alignment film 40 is formed on the surface 22a of the second substrate 22. The alignment film 40 is formed in the same manner as an alignment film used in a known liquid crystal display device. The alignment film 40 may also be formed in the same manner as the above-described alignment/insulation film 34.

Next, the alignment/insulation film 34 of the first substrate 20 and the alignment film 40 of the second substrate 22 are disposed in a face-to-face relationship so as to have a preset gap therebetween, and the first substrate 20 having the first electrodes 36 formed thereon and the second substrate 22 are attached to each other with a sealant while providing a liquid crystal injection port (Step S14).

Next, for example, a liquid crystal to be horizontally aligned is injected as the liquid crystal between the first substrate 20 and the second substrate 22 and the injection port is sealed with a UV-curable sealant to form the liquid crystal layer 24 (Step S16). In Step S16, the liquid crystal is injected so that at least a part of the surface 34a of the alignment/insulation film 34 comes into direct contact with the liquid crystal. The liquid crystal display device 10 can be manufactured by the above-described process.

A conventional liquid crystal display device 100 is illustrated in FIG. 5. The conventional liquid crystal display device 100 illustrated in FIG. 5 corresponds to the liquid crystal display device 10 illustrated in FIG. 1, and is a liquid crystal display device of the same fringe-field switching mode. In FIG. 5, the same structural elements as those of the liquid crystal display device 10 illustrated in FIG. 1 are denoted by the same numerals and are not described in detail.

As compared to the liquid crystal display device 10 illustrated in FIG. 1, in the conventional liquid crystal display device 100 illustrated in FIG. 5, no alignment/insulation film 34 is formed, an inorganic insulating film 110 is formed on the second electrode 38, and the first electrodes 36 are formed on the inorganic insulating film 110. On the inorganic insulating film 110 is further formed an alignment film 112, which covers the first electrodes 36.

The inorganic insulating film 110 is composed of, for example, silicon nitride. The alignment film 112 is the same as the alignment film 40 of the liquid crystal display device 10 illustrated in FIG. 1.

The conventional liquid crystal display device 100 includes the inorganic insulating film 110 and the alignment film 112. In contrast, the liquid crystal display device 10 includes the alignment/insulation film 34 which doubles as the insulating film and the alignment film, whereby the number of formed layers is reduced as compared to the conventional liquid crystal display device 100 to enable structural simplification. Therefore, the number of steps in the manufacturing process can be also reduced as compared to the conventional liquid crystal display device 100 to enable simplification of the manufacturing process.

Since the alignment treatment is performed after the completion of the step of forming the thin-film transistors, deterioration of the alignment properties in the step of forming the thin-film transistors is minimized.

Since a wet process such as an application for forming an alignment film is not necessary after the electrodes are formed, the liquid crystal display device using the horizontally aligned liquid crystal can be manufactured at low cost.

By disposing the spacers 42 on the first electrodes 36, the liquid crystal display device 10 can be configured in such a manner that the alignment/insulation film 34 does not come into contact with the spacers 42. Therefore, a foreign substance is prevented from occurring due to friction between the spacers 42 and the alignment/insulation film 34 during the operation of the touch panel.

### Second Embodiment

A second embodiment of the present invention is described below.

FIG. 4 is a schematic cross-sectional view illustrating a structure of a liquid crystal display device according to the second embodiment of the present invention.

In a liquid crystal display device 12 illustrated in FIG. 4, the same structural elements as those of the liquid crystal display device 10 illustrated in FIG. 1 are denoted by the same numerals and are not described in detail.

The liquid crystal display device 12 illustrated in FIG. 4 is of an IPS (In-Plane Switching) mode and differs in drive mode from the liquid crystal display device 10 illustrated in FIG. 1.

As compared to the liquid crystal display device 10 illustrated in FIG. 1, the liquid crystal display device 12 according to this embodiment does not have the organic planarization layer 32 and an alignment/insulation film 44 also serves as an organic planarization layer. In addition, the electrode configuration is different and comb-shaped electrodes 46 are formed on a surface 44a of the alignment/insulation film 44. Although not shown, the comb-shaped electrodes 46 and the thin-film transistors 28 of the thin-film transistor array layer 26 are electrically connected to each other. Therefore, while the alignment/insulation film 44, which also serves as an organic planarization layer, preferably has a flat surface, the alignment/insulation film 44 may be provided with contact holes, bumps, grooves, and the like if necessary.

In the liquid crystal display device 12, the alignment/insulation film 44 is formed on the thin-film transistor array layer 26. The alignment/insulation film 44 has the same configuration as the alignment/insulation film 34 of the liquid crystal display device 10.

The alignment/insulation film 44 is configured to electrically insulate the thin-film transistors 28, as is the case with the alignment/insulation film 34 illustrated in FIG. 1. In addition to this, the alignment/insulation film 44 should prevent the parasitic capacitance from being generated between the thin-film transistors 28 and the electrodes 46. For this reason, the alignment/insulation film 44 preferably has a thickness of at least 1 μm, and more preferably at least 2 μm. The upper limit is preferably up to 5 μm, more preferably up to 4 μm, and even more preferably up to 3 μm.

The liquid crystal display device 12 also includes the spacers 42. The spacers 42 are disposed on the electrodes 46 on the first substrate 20 side and on the surface 40a of the alignment film 40 on the second substrate 22 side. The spacers 42 may be disposed on the surface 44a of the alignment/insulation film 44 on the first substrate 20 side.

Transparent conductive materials such as indium tin oxide (ITO), aluminum zinc oxide (AZO), and indium zinc oxide (IZO) can be used for the electrodes 46 as for the first electrodes 36 and the second electrode 38. In addition to these, use may be made of metallic materials such as aluminum and copper, and alloy materials using these metallic materials.

Next, a method of manufacturing the liquid crystal display device 12 is described.

In the method of manufacturing the liquid crystal display device 12, the same steps as those of the method of manufacturing the liquid crystal display device 10 illustrated in FIG. 1 are not described in detail.

As compared to the method of manufacturing the liquid crystal display device 10 illustrated in FIG. 1, the method of manufacturing the liquid crystal display device 12 has the same steps up to the step of forming the thin-film transistor array layer 26, and hence a detailed description is omitted.

In the liquid crystal display device 12, after forming the thin-film transistor array layer 26, the alignment/insulation film 44 is formed thereon. The step of forming the alignment/insulation film 44 is the same as the step for the alignment/insulation film 34 of the liquid crystal display device 10, and hence its detailed description is omitted.

Next, ITO (indium tin oxide) is used to form a transparent conductive film on the whole of the surface 44a of the alignment/insulation film 44 by, for example, a sputtering process and the transparent conductive film is then processed into a comb shape by, for example, a wet etching process to form the comb-shaped electrodes 46.

In the same manner as the method of manufacturing the liquid crystal display device 10, the second substrate 22 having the alignment film 40 formed on the surface 22a thereof is prepared, and the first substrate 20 and the second substrate 22 are attached to each other with a sealant while providing a liquid crystal injection port. Then, for example, a liquid crystal to be horizontally aligned is injected from the injection port so as to come into direct contact with at least a part of the surface 44a of the alignment/insulation film 44 and the injection port is sealed with a UV-curable sealant. The liquid crystal display device 12 can be manufactured by the above-described process.

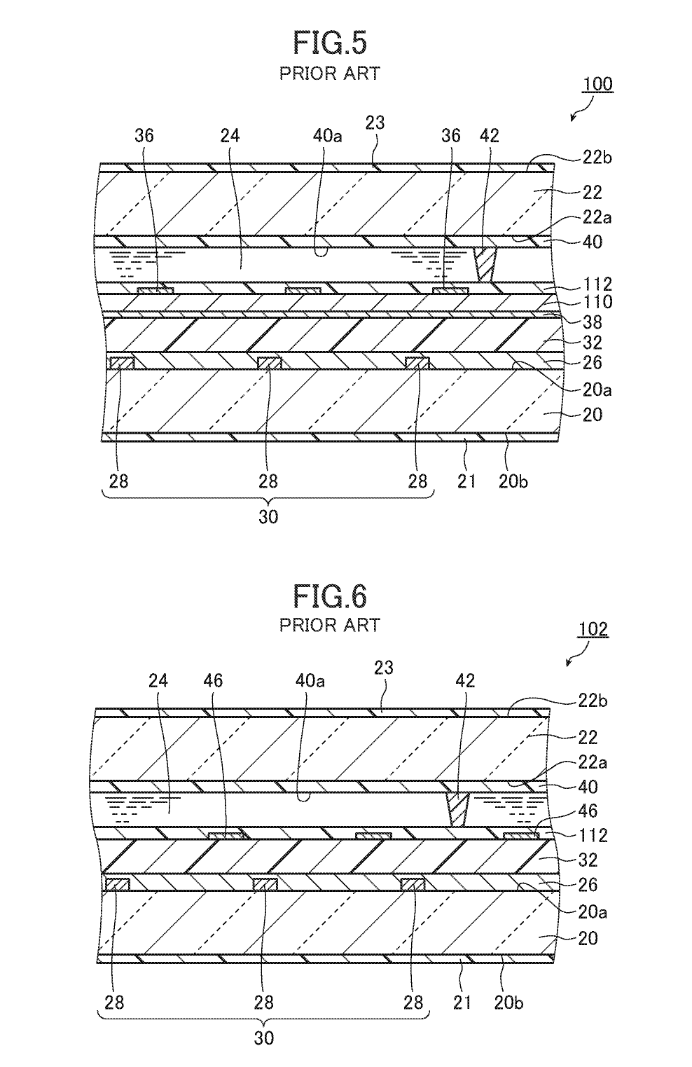

A conventional liquid crystal display device 102 is illustrated in FIG. 6. The conventional liquid crystal display device 102 illustrated in FIG. 6 corresponds to the liquid crystal display device 12 illustrated in FIG. 4, and is a liquid crystal display device of the same mode. In FIG. 6, the same structural elements as those of the liquid crystal display device 12 illustrated in FIG. 4 are denoted by the same numerals and are not described in detail.

As compared to the liquid crystal display device 12 illustrated in FIG. 4, in the conventional liquid crystal display device 102 illustrated in FIG. 6, the alignment/insulation film 44 is not formed, the organic planarization layer 32 is formed on the thin-film transistor array layer 26, and the comb-shaped electrodes 46 are formed on the organic planarization layer 32. On the organic planarization layer 32 is further formed an alignment film 112, which covers the comb-shaped electrodes 46.

The organic planarization layer 32 is the same as the organic planarization layer 32 of the liquid crystal display device 10 illustrated in FIG. 1. The alignment film 112 is the same as the alignment film 40.

The conventional liquid crystal display device 102 includes the organic planarization layer 32 and the alignment film 112. In contrast, the liquid crystal display device 12 includes the alignment/insulation film 44 which doubles as the insulating film and the alignment film, whereby the number of formed layers is reduced as compared to the conventional liquid crystal display device 102 to enable structure simplification. Therefore, the number of steps in the manufacturing process can be also reduced as compared to the conventional liquid crystal display device 102 to enable simplification of the manufacturing process. In addition to the above, according to this embodiment, the same effects as in the liquid crystal display device 10 according to the first embodiment and its manufacturing method can be obtained.

The organic insulating film composition (1) for use in forming the organic planarization layer 32 is described below.

### SYNTHESIS EXAMPLE 1 OF ORGANIC INSULATING FILM COMPOSITION (1)

<Synthesis of MATHF (tetrahydro-2H-furan-2-yl methacrylate)>

Methacrylic acid (86 g, 1 mol) was cooled to 15° C. and camphorsulfonic acid (4.6 g, 0.02 mol) was added. To the solution was added dropwise 2-dihydrofuran (71 g, 1 mol, 1.0 equivalents). After stirring for 1 hour, saturated sodium hydrogen carbonate (500 mL) was added, and the solution was extracted with ethyl acetate (500 mL) and dried over magnesium sulfate. Insoluble matter was filtered off and the solution was concentrated under reduced pressure at a temperature of 40° C. or lower. The yellow oil residue was distilled under reduced pressure to obtain as a colorless oil 125 g of tetrahydro-2H-furan-2-yl methacrylate (MATHF) which is a fraction at a boiling point (b.p.) of 54° C. to 56° C./3.5 mmHg (yield: 80%).

<Synthesis of Polymer A>

HS-EDM (diethylene glycol ethyl methyl ether manufactured by Toho Chemical Industry Co., Ltd.; 82 parts) was heated to 90° C. with stirring under a gaseous nitrogen stream. A mixture solution of MATHF (the tetrahydro-2H-furan-2-yl methacrylate as obtained above; 43 parts (corresponding to 40.5 mol % of the whole monomer ingredients)), (3-ethyloxetan-3-yl)methyl methacrylate (trade name: OXE-30, Osaka Organic Chemical Industry Ltd.; 48 parts (corresponding to 37.5 mol % of the whole monomer ingredients)), methacrylic acid (MAA, Wako Pure Chemical Industries, Ltd.; 6 parts (corresponding to 9.5 mol % of the whole monomer ingredients)), hydroxyethyl methacrylate (HEMA, Wako Pure Chemical Industries, Ltd.; 11 parts (corresponding to 12.5 mol % of the whole monomer ingredients)), a radical polymerization initiator V-601 (trade name; Wako Pure Chemical Industries, Ltd.; 4.3 parts), and propylene glycol monomethyl ether acetate (PGMEA; 82 parts) was added dropwise to the above-described HS-EDM (diethylene glycol ethyl methyl ether) over 2 hours, and the mixture was further reacted at 90° C. for 2 hours to obtain a solution of polymer A in PGMEA (propylene glycol monomethyl ether acetate) (solid concentration: 40%). The weight-average molecular weight of the resulting polymer A as measured by gel permeation chromatography (GPC) was 15,000.

Binder, the above-described polymer A, 46.3 g

Photoacid generator, trade name: PAG-103 (BASF), 0.435 g

Solvent, HS-EDM (diethylene glycol ethyl methyl ether manufactured by Toho Chemical Industry Co., Ltd.), 52.2 g

Crosslinking agent, JER157S65 (epoxy crosslinking agent manufactured by Japan Epoxy Resins Co., Ltd.), 0.99 g

Adhesion promoter, γ-glycidoxypropyltrialkoxysilane (KBM-403 manufactured by Shin-Etsu Chemical Co., Ltd.), 0.599 g

Basic compounds

DBN: 1,5-diazabicyclo[4.3.0]-5-nonene (Tokyo Chemical Industry Co., Ltd.), 0.01 g

TPI: triphenyl imidazole (Wako Pure Chemical Industries, Ltd.), 0.01 g

Surfactant, perfluoroalkyl group-containing nonionic surfactant (F-554 manufactured by DIC Corporation), 0.02 g

The respective ingredients described above were mixed to obtain a homogeneous solution. The solution was then filtered through a polytetrafluoroethylene filter with a pore diameter of 0.2 μm to prepare the organic insulating film composition (1). The organic insulating film composition (1) prepared as described above is hereinafter referred to as “organic insulating film composition (P-1).”

### SYNTHESIS EXAMPLE 2 OF ORGANIC INSULATING FILM COMPOSITION (1)

The acid/epoxy binder B (hereinafter referred to as “binder solution B”) described in Synthesis Example 1 of JP 2961722 B was synthesized.

Binder solution B obtained by the above-described synthesis method (amount corresponding to 20.0 parts in terms of solid content)

Photosensitizing agent (TAS-200 manufactured by Toyo Gosei Co., Ltd.), 5.0 parts

Adhesion promoter (KBM-403 (trade name) manufactured by Shin-Etsu Chemical Co., Ltd.), 0.5 parts

Solvent, propylene glycol monomethyl ether acetate (PGMEA manufactured by Daicel Chemical Industries, Ltd.), 77.1 parts

Surfactant (MEGAFACE F172 manufactured by DIC Corporation), 0.005 parts

The respective ingredients described above were mixed to obtain a homogeneous solution. The solution was then filtered through a polytetrafluoroethylene filter with a pore diameter of 0.2 μm to prepare the organic insulating film composition (1).

### SYNTHESIS EXAMPLE 3 OF ORGANIC INSULATING FILM COMPOSITION (1)

A mixture solution of glycidyl methacrylate (GMA (Wako Pure Chemical Industries, Ltd., 26.51 parts (0.21 molar equivalent))), methacrylic acid (MAA (Wako Pure Chemical Industries, Ltd., 18.35 parts (0.24 molar equivalent))), styrene (St (Wako Pure Chemical Industries, Ltd., 41.62 parts (0.45 molar equivalent))), 3,4-epoxycyclohexylmethyl methacrylate (Wako Pure Chemical Industries, Ltd., 13.52 parts (0.10 molar equivalent)) and propylene glycol monomethyl ether acetate (PGMEA (257.0 parts)) was heated to 80° C. under a gaseous nitrogen stream. While this mixture solution was stirring, a mixture solution of a radical polymerization initiator V-65 (trade name, Wako Pure Chemical Industries, Ltd., 3 parts) and propylene glycol monomethyl ether acetate (PGMEA (Daicel Chemical Industries, Ltd., 100.0 parts)) was added dropwise over 2.5 hours. After the end of the dropwise addition, the resulting solution was reacted at 70° C. for 4 hours to obtain a solution in PGMEA (propylene glycol monomethyl ether acetate) (solid content concentration: 40%). The PGMEA (propylene glycol monomethyl ether acetate) solution is hereinafter referred to as “binder solution C.”

Binder solution C obtained by the above-described synthesis method, 65 parts

Dipentaerythritol hexaacrylate (A-DPH manufactured by Shin-Nakamura Chemical Co., Ltd.), 25 parts

OXE-01 (trade name, BASF), 10 parts

Solvent, propylene glycol monomethyl ether acetate (PGMEA manufactured by Daicel Chemical Industries, Ltd.), 59 parts

Diethylene glycol ethyl methyl ether (HS-EDM manufactured by Toho Chemical Industry Co., Ltd.), 7 parts

The respective ingredients described above were mixed to obtain a homogeneous solution. The solution was then filtered through a polytetrafluoroethylene filter with a pore diameter of 0.2 μm to prepare the organic insulating film composition (1).

The organic insulating film composition (2) for forming the alignment/insulation films 34 and 44 is described below.

### SYNTHESIS EXAMPLE OF ORGANIC INSULATING FILM COMPOSITION (2) OR ALIGNMENT FILM COMPOSITION

An alicyclic polyimide organic insulating film composition (2) was synthesized by reference to WO 2013/018904.

1,2,3,4-Cyclobutane tetracarboxylic acid dianhydride (196.34 g; Tokyo Chemical Industry Co., Ltd.; 1.00 mol) was dissolved in 2,394 g of 1-methyl-2-pyrrolidone (NMP) (Wako Pure Chemical Industries, Ltd.) to obtain a slurry. To the slurry was added 101.11 g of p-phenylenediamine (Tokyo Chemical Industry Co., Ltd.; 0.935 mol) and further added 1-methyl-2-pyrrolidone (NMP) so as to have a solid content concentration of 8 wt %. The mixture was stirred at room temperature for 24 hours to obtain a polyamic acid solution. The viscosity of the polyamic acid solution at a temperature of 25° C. was 115 mPa·s. This solution is hereinafter referred to as “organic insulating film composition (H-1).” The organic insulating film composition (H-1) has an absorption band in a wavelength range of about 220 nm to 300 nm.

The present invention is basically configured as described above. While the liquid crystal display device and its manufacturing method according to the present invention have been described above in detail, the present invention is by no means limited to the above embodiments, and various improvements and modifications may of course be made without departing from the spirit of the present invention.

### EXAMPLES

The effects of the liquid crystal display device of the present invention are described more specifically below.

In EXAMPLES, samples were prepared in Examples 1 and 2 and Comparative Examples 1 and 2 to verify the effects of the present invention.

In Examples 1 and 2 and Comparative Examples 1 and 2, thin-film transistors were not formed in each of liquid crystal display elements to simplify the configuration for verifying the effects. The liquid crystal display elements in Examples 1 and 2 and Comparative Examples 1 and 2 are configured in the same manner as the liquid crystal display device except that thin-film transistors are not formed.

### Example 1

The liquid crystal display element in Example 1 is a horizontally aligned liquid crystal element of an IPS (In-Plane Switching) mode in which an organic insulating film is in direct contact with a liquid crystal.

In Example 1, the insulating film is of a two-layer type. The element is configured by laminating in the order of substrate—first organic insulating film—second organic insulating film—comb electrodes—horizontally aligned liquid crystal-containing liquid crystal layer—alignment film. In the liquid crystal display element of Example 1, the organic insulating film is in direct contact with the horizontally aligned liquid crystal in portions where there are no comb electrodes.

Next, a method of manufacturing the liquid crystal display element in Example 1 is described.

In Example 1, a glass substrate was used as the first substrate. The above-described organic insulating film composition (P-1) was applied onto the first substrate by a spin coating process and preliminarily dried on a hot plate at 80° C. for 1 minute. After that, the composition was baked in a clean oven at 230° C. for 60 minutes to form the first organic insulating film with a thickness of 3 μm.

Then, the above-described organic insulating film composition (H-1) was applied onto the first organic insulating film by a printing process and preliminarily dried on a hot plate at 80° C. for 2 minutes. After that, the composition was baked in a clean oven at 240° C. for 30 minutes to form the second organic insulating film with a thickness of 150 nm on the first organic insulating film.

An ITO (indium tin oxide) transparent conductive film was formed by a sputtering process and was then processed into a comb shape by wet etching to form, at the central portion of the second organic insulating film, the comb electrodes each having a size of 1 cm×1 cm and capable of external connection. The above-described comb electrodes are transparent electrodes and five comb teeth having the same width are formed in a square region with a size of 1 cm×1 cm at equal intervals. In Example 1, the two comb electrodes were disposed on the second organic insulating film so that each tooth of one comb electrode is between two teeth of the other comb electrode.

A polarized UV exposure device (HC-2150PUFM manufactured by Lan Technical Service Co., Ltd.) was used to subject the first substrate having the comb electrodes formed thereon to photo alignment treatment of the second organic insulating film using polarized light showing sequential colors at wavelengths of 220 nm-330 nm and having an intensity of 1 J/cm², thereby obtaining the alignment/insulation film.

Next, a second substrate having the alignment film formed thereon was prepared. A glass substrate was used also as the second substrate. As for the alignment film, the organic insulating film composition (H-1) was applied onto the second substrate by a printing process and preliminarily dried on a hot plate at 80° C. for 2 minutes. After that, the composition was baked in a clean oven at 240° C. for 30 minutes to form a liquid crystal alignment film with a thickness of 150 nm on the second substrate. Then, a polarized UV exposure device (HC-2150PUFM manufactured by Lan Technical Service Co., Ltd.) was used to subject the liquid crystal alignment film to photo alignment treatment using polarized light showing sequential colors at wavelengths of 220 nm-330 nm and having an intensity of 1 J/cm², thereby obtaining the alignment film.

An epoxy resin sealant was used to attach the first substrate to the second substrate while keeping a cell gap of 3 μm, thereby obtaining a liquid crystal display cell.

Next, a liquid crystal composition for horizontal alignment MLC-2055 manufactured by Merck & Co., Inc. was injected into the liquid crystal display cell and the injection port was sealed with a UV-curable sealant. After that, polarizing plates were attached to both surfaces of the liquid crystal display cell so that the alignment direction was the same, thereby preparing the liquid crystal display element in Example 1.

As a result of observation of the liquid crystal display element of Example 1 on a light box (white light source), light transmitted uniformly and a display failure such as uneven alignment was not seen. In addition, as a result of application of square wave at ±5 V and 30 Hz to the liquid crystal display element in Example 1, a 1 cm×1 cm portion having the transparent comb electrodes was shielded from light and a good display was obtained.

### Example 2

The liquid crystal display element in Example 2 is a horizontally aligned liquid crystal element of an IPS (In-Plane Switching) mode in which an organic insulating film is in direct contact with a liquid crystal.

In Example 2, the insulating film is of a one-layer type. The element is configured by laminating in the order of substrate—organic insulating film—comb electrodes—horizontally aligned liquid crystal-containing liquid crystal layer—alignment film. In the liquid crystal display element of Example 2, the organic insulating film is in direct contact with the horizontally aligned liquid crystal in portions where there are no comb electrodes.

Next, a method of manufacturing the liquid crystal display element in Example 2 is described.

In Example 2, a glass substrate was used as the first substrate. The above-described organic insulating film composition (H-1) was applied onto the first substrate by a spin coating process and preliminarily dried on a hot plate at 80° C. for 1 minute. After that, the composition was baked in a clean oven at 240° C. for 60 minutes to form the organic insulating film with a thickness of 3 μm.

An ITO (indium tin oxide) transparent conductive film was formed by a sputtering process and was then processed into a comb shape by wet etching to form, at the central portion of the organic insulating film, the comb electrodes each having a size of 1 cm×1 cm and capable of external connection. The comb electrodes are transparent electrodes. In Example 2, the two comb electrodes were disposed on the organic insulating film in the same manner as in Example 1.

A polarized UV exposure device (HC-2150PUFM manufactured by Lan Technical Service Co., Ltd.) was used to subject the first substrate having the comb electrodes formed thereon to photo alignment treatment of the organic insulating film using polarized light showing sequential colors at wavelengths of 220 nm-330 nm and having an intensity of 1 J/cm², thereby obtaining the alignment/insulation film.

Next, a second substrate having the alignment film formed thereon in the same step as in Example 1 was prepared.

Then, an epoxy resin sealant was used to attach the first substrate to the second substrate while keeping a cell gap of 3 μm, thereby obtaining a liquid crystal display cell. Next, a liquid crystal composition for horizontal alignment MLC-2055 manufactured by Merck & Co., Inc. was injected into the liquid crystal display cell and the injection port was sealed with a UV-curable sealant. After that, polarizing plates were attached to both surfaces of the liquid crystal display cell so that the alignment direction was the same, thereby preparing the liquid crystal display element in Example 2.

As a result of observation of the liquid crystal display element of Example 2 on a light box (white light source), light transmitted uniformly and a display failure such as uneven alignment was not seen. In addition, as a result of application of square wave at ±5 V and 30 Hz to the liquid crystal display element in Example 2, a 1 cm×1 cm portion having the transparent comb electrodes was shielded from light and a good display was obtained.

### Comparative Example 1

The liquid crystal display element in Comparative Example 1 is of a fringe-field switching mode.

The element is configured by laminating in the order of substrate—organic insulating film—planar transparent electrode—inorganic insulating film—comb electrodes—alignment film—horizontally aligned liquid crystal-containing liquid crystal layer—alignment film. In the liquid crystal display element of Comparative Example 1, the alignment film is formed on the comb electrodes by coating and the organic insulating film is not in direct contact with the horizontally aligned liquid crystal.

Next, a method of manufacturing the liquid crystal display element in Comparative Example 1 is described.

In Comparative Example 1, a glass substrate was used as the first substrate. The organic insulating film composition (P-1) was applied onto the first substrate by a spin coating process and preliminarily dried on a hot plate at 80° C. for 1 minute. After that, the composition was baked in a clean oven at 230° C. for 60 minutes to form the organic insulating film with a thickness of 3 μm.

An ITO (indium tin oxide) transparent conductive film was formed by a sputtering process and was then processed into a planar shape by wet etching to form, at the central portion of the organic insulating film, the planar transparent electrode with a size of 1 cm×1 cm which is capable of external connection.

A SiNx film was formed on the planar transparent electrode by a sputtering process to obtain the inorganic insulating film. An ITO (indium tin oxide) transparent conductive film was formed again by a sputtering process and was then processed into a comb shape by wet etching to form, at the central portion of the inorganic insulating film, the comb electrodes each having a size of 1 cm×1 cm and capable of external connection. The comb electrodes are transparent electrodes.

The organic insulating film composition (H-1) was applied onto the substrate having the comb electrodes formed thereon by a printing process and preliminarily dried on a hot plate at 80° C. for 2 minutes. After that, the composition was baked in a clean oven at 240° C. for 30 minutes to form a liquid crystal alignment film with a thickness of 150 nm on the substrate.

Then, a polarized UV exposure device (HC-2150PUFM manufactured by Lan Technical Service Co., Ltd.) was used to subject the liquid crystal alignment film to photo alignment treatment using polarized light showing sequential colors at wavelengths of 220 nm-330 nm and having an intensity of 1 J/cm², thereby obtaining the alignment film.

Next, a second substrate having the alignment film formed thereon in the same step as in Example 1 was prepared.

Then, an epoxy resin sealant was used to attach the first substrate to the second substrate while keeping a cell gap of 3 μm, thereby obtaining a liquid crystal display cell. Next, a liquid crystal composition for horizontal alignment MLC-2055 manufactured by Merck & Co., Inc. was injected into the liquid crystal display cell and the injection port was sealed with a UV-curable sealant. After that, polarizing plates were attached to both surfaces of the liquid crystal display cell so that the alignment direction was the same, thereby preparing the liquid crystal display element in Comparative Example 1.

As a result of observation of the liquid crystal display element of Comparative Example 1 on a light box (white light source), light transmitted uniformly and a display failure such as uneven alignment was not seen. In addition, as a result of application of square wave at ±5 V and 30 Hz to the liquid crystal display element in Comparative Example 1, a 1 cm×1 cm portion having the transparent electrodes was shielded from light and a good display was obtained.

### Comparative Example 2

The liquid crystal display element in Comparative Example 2 is of an IPS (In-Plane Switching) mode.

The element is configured by laminating in the order of substrate—organic insulating film—comb electrodes—horizontally aligned liquid crystal-containing liquid crystal layer—alignment film. In the liquid crystal display element of Comparative Example 2, the horizontally aligned liquid crystal is not in direct contact with the organic insulating film.

Next, a method of manufacturing the liquid crystal display element in Comparative Example 2 is described.

In Comparative Example 2, a glass substrate was used as the first substrate. The above-described organic insulating film composition (P-1) was applied onto the first substrate by a spin coating process and preliminarily dried on a hot plate at 80° C. for 1 minute. After that, the composition was baked in a clean oven at 230° C. for 60 minutes to form the organic insulating film with a thickness of 3 μm.

An ITO (indium tin oxide) transparent conductive film was formed by a sputtering process and was then processed into a comb shape by wet etching to form, at the central portion of the organic insulating film, the comb electrodes each having a size of 1 cm×1 cm and capable of external connection. The comb electrodes are transparent electrodes. In Comparative Example 2, the two comb electrodes were disposed on the organic insulating film in the same manner as in Example 1.

Then, the organic insulating film composition (H-1) was applied onto the organic insulating film by a printing process so as to cover the comb electrodes and preliminarily dried on a hot plate at 80° C. for 2 minutes. After that, the composition was baked in a clean oven at 240° C. for 30 minutes to form a liquid crystal alignment film with a thickness of 150 nm on the substrate. Then, a polarized UV exposure device (HC-2150PUFM manufactured by Lan Technical Service Co., Ltd.) was used to subject the liquid crystal alignment film to photo alignment treatment using polarized light showing sequential colors at wavelengths of 220 nm-330 nm and having an intensity of 1 J/cm², thereby obtaining the alignment film.

Next, a second substrate having the alignment film formed thereon in the same step as in Example 1 was prepared.

Then, an epoxy resin sealant was used to attach the first substrate to the second substrate while keeping a cell gap of 3 μm, thereby obtaining a liquid crystal display cell. Next, a liquid crystal composition for horizontal alignment MLC-2055 manufactured by Merck & Co., Inc. was injected into the liquid crystal display cell and the injection port was sealed with a UV-curable sealant. After that, polarizing plates were attached to both surfaces of the liquid crystal display cell so that the alignment direction was the same, thereby preparing the liquid crystal display element in Comparative Example 2.

As a result of observation of the liquid crystal display element of Comparative Example 2 on a light box (white light source), light transmitted uniformly and a display failure such as uneven alignment was not seen. In addition, as a result of application of square wave at ±5 V and 30 Hz to the liquid crystal display element in Comparative Example 2, a 1 cm×1 cm portion having the transparent electrodes was shielded from light and a good display was obtained.

As described above, the liquid crystal display elements in Examples 1 and 2 and Comparative Example 2 are all of an IPS (In-Plane Switching) mode. The liquid crystal display element in Comparative Example 1 is of a fringe-field switching mode. In Examples 1 and 2 in which the structures are simplified, as in Comparative Examples 1 and 2, light transmitted uniformly, a display failure such as uneven alignment was not seen, and a good display was obtained.

The configuration of the liquid crystal display device according to the present invention does not need to subject the alignment film to a wet process after the electrode formation, and hence a liquid crystal display device using a horizontally aligned liquid crystal can be manufactured at low cost.

What is claimed is:

1. A liquid crystal display device comprising:
a liquid crystal layer;
a first substrate comprising thin-film transistors configured to drive liquid crystal molecules of the liquid crystal layer, at least one type of electrode, and an insulating film, at least a part of which is in direct contact with the liquid crystal layer, one of the at least one type of electrode being disposed on the insulating film; and
a second substrate disposed so as to be opposed to the first substrate with the liquid crystal layer interposed between the first substrate and the second substrate,
wherein the insulating film has a function of aligning the liquid crystal molecules of the liquid crystal layer.

2. The liquid crystal display device according to claim 1,
wherein the first substrate further comprises an organic planarization layer formed on the thin-film transistors,
wherein the at least one type of electrode comprises a first electrode and a second electrode formed on the organic planarization layer,
wherein the insulating film is interposed between the first electrode and the second electrode, and
wherein the first electrode is a comb-shaped electrode.

3. The liquid crystal display device according to claim 1,
wherein the first substrate comprises the insulating film formed on the thin-film transistors,
wherein the at least one type of electrode is formed on the insulating film, and
wherein the at least one type of electrode is a comb-shaped electrode and the insulating film also serves as an organic planarization layer.

4. The liquid crystal display device according to claim 1, wherein the insulating film has photo alignment properties.

5. The liquid crystal display device according to claim 1, wherein an organic insulating film precursor configured to form the insulating film has photo alignment properties.

6. The liquid crystal display device according to claim 2, wherein the insulating film has a thickness of up to 1 μm.

7. The liquid crystal display device according to claim 3, wherein the insulating film has a thickness of at least 2 μm but up to 5 μm.

8. The liquid crystal display device according to claim 1, wherein spacers configured to keep a distance between the first substrate and the second substrate are formed between the first substrate and the second substrate.

9. The liquid crystal display device according to claim 8, wherein the spacers are disposed at positions corresponding to the at least one type of electrode.

10. A method of manufacturing a liquid crystal display device comprising a liquid crystal layer, and a first substrate and a second substrate disposed so as to be opposed to each other with the liquid crystal layer interposed between the first substrate and the second substrate, the method comprising:
a step of forming, on the first substrate, thin-film transistors configured to drive liquid crystal molecules of the liquid crystal layer, an insulating film, and one of at least one type of electrode on the insulating film;
a step of attaching the first substrate and the second substrate to each other; and
a step of injecting a liquid crystal between the first substrate and the second substrate before or after the step of attaching the first substrate and the second substrate to each other so that at least a part of the insulating film comes into direct contact with the liquid crystal,
wherein a step of forming the insulating film comprises a step of forming a film constituting the insulating film using an organic material having photo alignment properties and a step of imparting a function of aligning the liquid crystal molecules through irradiation of at least a part of the film with polarized light.

11. The method of manufacturing a liquid crystal display device according to claim 10, wherein formation of the thin-film transistors is followed by formation of one of the at least one type of electrode and another of the at least one type of electrode is formed on the insulating film.

12. The method of manufacturing a liquid crystal display device according to claim 10, wherein formation of the thin-film transistors is followed by formation of the insulating film, which is followed by formation of the at least one type of electrode.

13. The method of manufacturing a liquid crystal display device according to claim 10, wherein the step of forming the insulating film comprises subjecting the film to heat curing treatment before or after the irradiation with the polarized light.

14. The method of manufacturing a liquid crystal display device according to claim 10, wherein the polarized light has a wavelength of 200 nm-400 nm.

15. The method of manufacturing a liquid crystal display device according to claim 10, wherein the injected liquid crystal is a liquid crystal to be horizontally aligned.
